(19) United States
(12) Patent Application Publication
(10) Pub. No.: US 2009/0271327 A1
(43) Pub. Date: Oct. 29, 2009

(54) PAYMENT PORTFOLIO OPTIMIZATION

(76) Inventors: Raghav Lal, Palo Alto, CA (US); Cindy Y. Rentala, Foster City, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/108,354

(22) Filed: Apr. 23, 2008

(51) Int. Cl. G06Q 40/00

(52) U.S. Cl. 705/36 R

(57) ABSTRACT

A method and system of payment portfolio optimization that retrieves a plurality of consumer segments of a consumer portfolio from a diagnostics module where the consumer segments have potentially profitable opportunities. The method and system also develop a propensity model on a computer based on at least one performance metric, determine a likelihood from the propensity model that consumers in each of the plurality of consumer segments will perform favorably. The method and system also selects a set of consumer segments from the plurality of consumer segments based on the determined likelihood and designs a plurality of marketing treatments for the selected set of consumer segments.

### BACKGROUND

Traditionally, an issuer, e.g. a bank, examines its own consumers' spending behaviors to find potential opportunities for increasing revenue. The issuer may compare the performance of its consumer portfolio to the performance of the portfolios of other issuers to identify a general opportunity for growth. The issuer defines opportunities for a marketing analyst and the marketing analyst recommends marketing treatments. For example, a bank issuing credit cards may have evaluated their business accounts and discovered that they have low activation rates on their business credit cards. The bank might present this problem to a marketing analyst. The analyst could recommend sending out a mass mailing to remind these consumers to activate their cards. In another example, a bank may have evaluated its business accounts and discovered that most consumers with active business credit cards rarely use their cards. In this example, the analyst may recommend that the bank create a rewards plan for their business card accounts.

The issuer typically evaluates its own consumers' spending behaviors using information available over a “closed network” which is not generally open for use by other independently operated issuers. Because the closed network receives a limited amount of data and cannot perform an optimum analysis of potential revenue growth opportunities, the issuer using the closed network may miss opportunities and potentially lose revenue.

Sometimes, propensity models are used to predict the likelihood that consumers will respond to marketing treatments. Typically, multiple propensity models are developed with each model predicting the likelihood of improving performance in a single area such as penetration, activation, usage, attrition, etc. Since each model addresses only a single area, multiple combinations of marketing treatments result. If each combination of marketing treatments is pursued, marketing funds may be wasted that could be used to take advantage of other potential opportunities.

Embodiments of the present disclosure address these and other problems, individually and collectively.

### SUMMARY OF THE INVENTION

Embodiments of the invention are directed to methods and systems for payment portfolio optimization.

In some embodiments, information is collected from an issuer about its consumer portfolio. The consumer portfolio is segmented based on shared characteristics. The collected information is used to identify potential opportunities for increasing revenue in particular consumer segments. The opportunities are evaluated based on predicted net revenue that could be generated if the opportunities are realized. The consumer segments with the most profitable opportunities are selected. A likelihood that each consumer will act on marketing treatments is assessed. Each consumer is ranked based on this likelihood and the most promising consumers are selected as targets of a marketing plan. The marketing plan is designed and tested based on multiple factors simultaneously to determine whether the marketing treatments in the marketing plan will successfully target the most promising consumers. The marketing plan is modified to include only the successful marketing treatments. An improved successful marketing plan is delivered to the issuer that targets the most promising consumers and optimizes return on investment (ROI) to the issuer.

One embodiment of the invention is a method of payment portfolio optimization that retrieves a plurality of consumer segments of a consumer portfolio from a diagnostics module. The plurality of consumer segments having potentially profitable opportunities. The method also develops a propensity model on a computer based on at least one performance metric, determines, using the propensity model, a likelihood that consumers in each of the plurality of consumer segments will perform favorably. The method also selects a set of consumer segments from the plurality of consumer segments based on the determined likelihood and designs a plurality of marketing treatments for the selected set of consumer segments.

Another embodiment of the invention is a system of payment portfolio optimization that comprises a database for storing information and a financial modeling module coupled to the database. The financial modeling module on a computer retrieves a plurality of consumer segments of a consumer portfolio from a diagnostics module. The plurality of consumer segments have profitable opportunities. The system also develops a propensity model based on at least one performance metric and determines, using the propensity model, a likelihood that consumers in each of the plurality of consumer segments will perform favorably. The system also selects a set of consumer segments from the plurality of consumer segments based on the determined likelihood and designs a plurality of marketing treatments for the selected set of consumer segments.

These and other embodiments of the invention are described in further detail below.

### BRIEF DESCRIPTION OF THE DRAWINGS

FIG. 1 is a block diagram illustrating a payment portfolio optimization system, in accordance with an embodiment of the invention.

FIG. 2 is a flowchart illustrating a method of payment portfolio optimization that includes diagnosing opportunities in the consumer portfolio, developing targeting tools, designing and launching a pilot marketing plan, and rolling out a successful marketing plan, in accordance with an embodiment of the invention.

FIG. 3 is a flowchart illustrating a method of payment portfolio optimization, in accordance with an embodiment of the invention.

### DETAILED DESCRIPTION

Embodiments of the invention address the above-noted problems by providing a method and system of payment portfolio optimization that uses information about issuer's consumers to identify and evaluate potential opportunities for increased net revenue to the issuer. This information is used to develop optimal marketing treatments for the issuer that target only those consumers with the greatest likelihood of responding to the marketing treatments.

In some embodiments, information is collected from an issuer about its consumer portfolio. The consumer portfolio is segmented based on shared characteristics. The collected information is used to identify potential opportunities for increasing revenue in particular consumer segments. The opportunities are evaluated based on predicted net revenue that could be generated if the opportunities are realized. The consumer segments with the most profitable opportunities are selected. A likelihood that each consumer will act on marketing treatments is assessed. Each consumer is ranked based on this likelihood and the most promising consumers are selected as targets of a marketing plan. The marketing plan is designed and tested based on multiple factors simultaneously to determine whether the marketing treatments in the marketing plan will successfully target the most promising consumers. The marketing plan is modified to include only the successful marketing treatments. An improved successful marketing plan is delivered to the issuer that targets the most promising consumers and optimizes return on investment (ROI) to the issuer.

Certain embodiments of the invention may provide one or more technical advantages to issuers and consumers. One technical advantage to an issuer may be that using this method and system may provide better customized marketing plans that optimize the return on investment to the issuer. Another technical advantage to the issuer may be reducing marketing expenditures since a single marketing plan can be developed that improves performance in multiple areas. Also, a technical advantage to an issuer may be that using this method and system may more accurately define opportunities for revenue growth since they can be based on information available from one or more sources. Another technical advantage to an issuer may be that an issuer can reduce their marketing expenditures by benchmarking performance of consumer segments to determine potential improvement to better understand where to focus marketing funds. A technical advantage to a consumer may be that the consumer may be more likely to learn of products or services that will benefit them or their businesses.

Certain embodiments of the invention may include none, some, or all of the above technical advantages. One or more other technical advantages may be readily apparent to one skilled in the art from the figures, descriptions, and claims included herein.

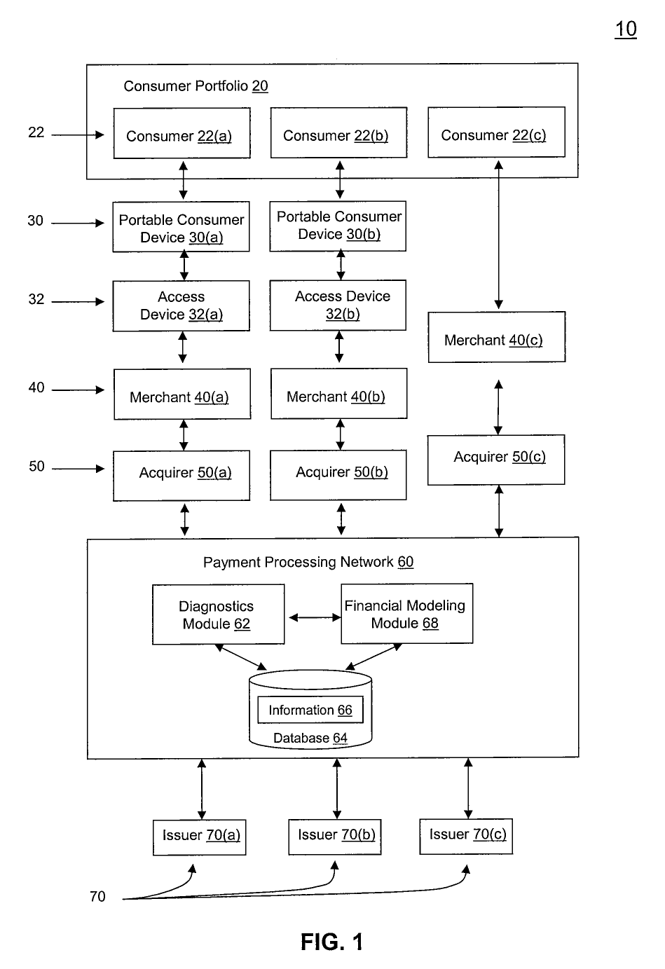

FIG. 1 is a block diagram illustrating a payment portfolio optimization system 10, in accordance with an embodiment of the invention. Payment portfolio optimization system 10 includes a consumer portfolio 20 having three consumers 22(a), 22(b) and 22(c). Payment portfolio optimization system 10 also includes portable consumer devices 30(a) and 30(b) in operative communication with consumers 22(a) and 22(b) and access devices 32(a) and 32(b) for interacting with portable consumer devices 30(a) and 30(b). Payment portfolio optimization system 10 also includes three merchants 40(a), 40(b), and 40(c). Merchant 40(a) is in operative communication with access device 32(a) that can interact with portable consumer device 30(a). Merchant 40(b) is in operative communication with access device 32(b) that can interact with portable consumer device 30(b). Merchant 40(c) is in operative communication with consumer 22(c) to accept payment in the form of checks or cash. Payment portfolio optimization system 10 also includes acquirers 50 that are associated with merchants 40.

Payment processing network 60 is in operative communication with acquirers 50 and issuers 70. In other embodiments, payment processing network 60 is in operative communication with other entities such as other consumers, other issuers, marketing analysts, and organizations such as credit bureaus, credit agencies for collecting information 66 that may be useful in payment portfolio optimization.

Payment portfolio optimization system 10 includes a payment processing network 60 having a diagnostic module 62, a financial modeling module 66, and a database 64 having information 66. Diagnostics module 62 is in communication with database 64 for retrieving information 66 used to diagnosis opportunities in consumer portfolio 20 and for storing information 66 such as the diagnosed opportunities. Diagnostics module 62 is also in communication with issuer 70(a) to receive information for payment portfolio optimization. Financial modeling module 68 is in communication with database 64 for retrieving information 66 used to develop targeting tools, design and launch a pilot marketing plan, and roll out a successful marketing plan. Financial modeling module 68 is also in communication with issuer 70(a) to deliver the successful marketing plan to issuer 70(a). The marketing plan includes marketing treatments that optimize the potential for maximum revenue to issuer 70(a) from consumer portfolio 20.

Marketing treatments refer to methods of marketing products to consumers 22 targeted by financial modeling module 68. In some cases, the products are customized based on the characteristics of consumers 22. Marketing treatments can be of any suitable type. Examples of types of marketing treatments include solicitations, educational messages, and offers. Marketing treatments can be given to consumers 22 by any suitable method (e.g., online). Examples of online marketing treatments include e-coupons, games, surveys, video streaming, data management, and search engine marketing.

Although diagnostics module 62 and financial modeling module 68 are shown as being part of the payment processing network 60, they may be outside payment processing network 60 in other embodiments. Diagnostics module 62 and/or financial modeling module 68 may be embodied by software code that resides on one or more computers within payment processing network 60. Any of the functions performed by the diagnostics module 62 and/or financial modeling module 68 may be embodied by computer code, and/or instructions which may be executed by one or more processors.

Payment portfolio optimization system 10 also includes issuers 70 for issuing portable consumer devices 30(a) to consumer 22(a), issuing portable consumer device 30(b) to consumer 22(b), and for issuing checks to consumer 22(c). Consumer 22(a) has a checking account with issuer 70(a) that is associated with portable consumer device 30(a) and a checking account with issuer 70(c) that is not associated with a portable consumer device 30. Consumer 22(b) has a checking account with issuer 70(a) that is associated with portable consumer device 30(b) and a checking account with issuer 70(b). Consumer 22(c) has a checking account with issuer 70(a) and a checking account with issuer 70(c). Although payment portfolio optimization system 10 is shown with three issuers 70 and with three consumers 22, there may be any suitable number of issuers 70 and consumers 22 in payment portfolio optimization system 10. In addition, issuers 70 may have any suitable number or type of account with any suitable number of consumers 22.

In a typical payment transaction, consumer 22(a) may purchase goods or services at merchant 40(a) using portable consumer device 30(a) at access device 32(a) and consumer 22(b) may purchase goods or services at merchant 40(b) using portable consumer device 30(b) at access device 32(b). Consumer 22(c) may purchase goods or services at merchant 40(c) using cash or check.

Consumers 22 refer to entities that are capable of purchasing goods or services or making any suitable transaction with merchant 40. In some cases, consumers 22 may be organizations such as businesses. For example, consumers 22 may be small business owners.

Consumer portfolio 20 refers to any suitable collection of consumers 22 that have an account with issuer 70(a). An account may be any suitable type of account such as a business account, an individual checking account, an individual savings account, etc. Although three consumers 22(a), 22(b), and 22(c) are shown in consumer portfolio 20, any suitable number of consumers 22 may be present in consumer portfolio 20. Also, any suitable number of prospective consumers 22 may be present outside of consumer portfolio 20.

In the illustrated embodiment, diagnostics module 62 and financial modeling module 68 optimize consumer portfolio 20 of issuer 70(a). In other embodiments, diagnostics module 62 and financial modeling module 68 may optimize opportunities associated with prospective consumers 22 outside of consumer portfolio 20.

A consumer characteristic refers to any suitable attribute (e.g. a spend behavior) that describes consumer 22, the account associated with consumer 22, the portable consumer device 30 of consumer 22, one or more issuers 70, or other suitable entity. For example, a consumer characteristic can be the extent of their automated clearing house (ACH), cash, and check usage where a relative heavy usage suggests that there may be an opportunity to migrate the consumer 22 to a portable consumer device 30. As another example, a consumer characteristic can be the amounts and quantities of the transactions made by consumer 22 using portable consumer device 30. In some cases, a consumer can be characterized as “light user,” “medium user,” “heavy user,” or “super-heavy user” based on the amounts and quantities of the transactions Another example of a consumer characteristic can be the way in which portable consumer device 30 is used by consumer 20. In this example, consumer can be characterized as “offline” when consumer's portable consumer device 30 requires a signature at point of sale (POS) or “online” where the consumer's portable consumer device 30 requires a PIN at POS. In yet another example, a consumer characteristic can be whether or not transactions are made using portable consumer device 30. A consumer not associated with portable consumer device 30 is characterized as “uncarded” and a consumer associated with portable consumer device 30 is characterized as “carded.” Another consumer characteristic can be whether portable consumer device 30 of consumer 20 has been activated. A consumer can be characterized as “active” when the portable consumer device 30 has been activated and used at a POS or characterized as “inactive” where the portable consumer device 30 has not been activated or activated but not used at POS. Another consumer characteristic can be whether or not the consumer's account is open. A consumer 20 with an open account can be characterized as “open” and a consumer 20 with a closed account can be characterized as “closed.” Another consumer characteristic can be their location such as county, state, or region (e.g., Northeast region of the U.S.). Another example of a consumer characteristic may be whether consumer 20 has a rewards plan associated with their account. Consumers may have any number consumer characteristics. For example, a consumer can be an “active,” “carded,” “super-heavy user,” where the consumer has an active account with issuer 70(a) that is associated with a portable consumer device 30(a) and that the consumer is a super-heavy user of the portable consumer device 30(a).

A consumer segment refers to a subset of consumers 22 that share a set of consumer characteristics. For example, all consumers 22 in consumer portfolio 20 have an account with issuer 70(a) but only consumer 22(c) does not have a portable consumer device 30 associated with their account. One consumer segment may consist of consumer 22(a) and consumer 22(b) with a set of consumer characteristics consisting of “carded.” Another consumer segment may consist of consumer 22(c) with a set of consumer characteristics consisting of “uncarded.”

Consumer segmentation refers to the separation of consumers into consumer segments based on segment definitions. In the illustrated embodiment, only consumers 22 in consumer portfolio 20 are segmented. In other embodiments, consumers in consumer portfolio 20 and outside of consumer portfolio 20 are segmented. A segment definition refers to a set of consumer characteristics that define a consumer segment. A segment definition may include any suitable number of characteristics. For example, a segment definition may include “carded, “active” consumers that is consumers with active cards. In another example, a segment definition may include “offline,” “carded,” “super-heavy user,” that is the consumers with open accounts having an active portable consumer device that requires a signature at the POS where the consumer is a super-heavy user of their portable consumer device. Segment definitions may be defined by issuer 70(a), by diagnostics module 62, or by any other suitable entity. In some cases, segment definitions may be based on information 66 that is available over the payment processing network 60.

Portable consumer device 30 refers to any suitable device that allows the transaction to be conducted with merchant 40 and that is associated with an account of issuer 70. Portable consumer device 30 may be in any suitable form. For example, suitable portable consumer devices 30 can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of portable consumer devices 30 include cellular phones, personal digital assistants (PDAs), pagers, payment cards, security cards, access cards, smart media, transponders, and the like.

In some embodiments, portable consumer device 30 may comprise a computer readable medium and a body. The computer readable medium may be on the body of portable consumer device 30. The body may in the form of a plastic substrate, a housing, or other structure. The computer readable medium may be a memory that stores data and may be in any suitable form. Exemplary computer readable media may be in any suitable form including a magnetic stripe, a memory chip, etc. If portable consumer device 30 is in the form of a card, it may have an embossed region (ER) which is embossed with a PAN (primary account number). Computer readable medium may electronically store the PAN as well as other data such as PIN data.

Merchant 40 refers to any suitable entity or entities that makes a transaction with consumer 22. Merchant 40 may use any suitable method to make the transaction. For example, merchant 40 may use an e-commerce business to allow the transaction to be conducted by merchant 40 through the Internet. Other examples of merchant 40 include a department store, a gas station, a drug store, a grocery store, or other suitable business.

Access device 32 may be any suitable device for communicating with merchant 40 and for interacting with portable consumer device 30. Access device 32 can be in any suitable location such as at the same location as merchant 40. Access device 32 may be in any suitable form. Some examples of access devices include POS devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, websites, and the like. Access device 32 may use any suitable contact or contactless mode of operation to send or receive data from portable consumer devices 30.

If access device 32 is a POS terminal, any suitable POS terminal may be used and may include a reader, a processor, and a computer readable medium. Reader may include any suitable contact or contactless mode of operation. For example, exemplary card readers can include radio frequency (RF) antennas, optical scanners, bar code reader, magnetic stripe readers, etc. to interact with portable consumer device 30.

Acquirer 50 refers to any suitable entity that has an account with merchant 40. In some embodiments, issuer 70 may also be acquirer 50.

Issuer 70 refers to suitable entity that may open and maintain an account for consumer 22. Some examples of issuers may be a bank, a business entity such as a retail store, or a governmental entity. In many cases, issuer 70 may also issue portable consumer devices 30 associated with account to consumer 22. For example, issuer 70(a) issued portable consumer device 30(a) to consumer 22(a) and issued portable consumer device 30(b) to consumer 22(b).

Payment processing network 60 refers to a network of suitable entities that have information 66 for payment portfolio optimization. Although payment processing network 60 is shown with two modules, diagnostics module 62 and financial modeling module 68, payment processing network 60 may have suitable number of modules. Payment processing network 60 may also have or operate a server computer. The server computer may be coupled to database 64 and may include any hardware, software, other logic, or combination of the preceding for servicing the requests from one or more client computers. Server computer may use any of a variety of computing structures, arrangements, and compilations for servicing the requests from one or more client computers. In one embodiment, the server computer may be a powerful computer or cluster of computers. For example, the server computer can be a large mainframe, a minicomputer cluster, or a group of servers functioning as a unit. In one example, the server computer may be a database server coupled to a Web server. Server computer services the requests of one or more client computers.

Payment processing network 60 may include data processing subsystems, networks, and operations used to support and deliver authorization services, exception file services, and clearing and settlement services. An exemplary payment processing network 60 may include VisaNet™. Networks that include VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. Payment processing network 60 may use any suitable wired or wireless network, including the Internet.

Database 64 may include any hardware, software, firmware, or combination of the preceding for storing and facilitating retrieval of information 64. Also, database 64 may use any of a variety of data structures, arrangements, and compilations to store and facilitate retrieval of information. In the illustrated embodiment, database 64 is located in payment processing network 60. Database 64 may be located on other components of payment portfolio optimization system 10 in other embodiments. For example, database 64 may be located on a server available over payment processing network 60.

Diagnostics module 62 and financial modeling module 60 store information 66 to database 64 and retrieve information 66 from database 64. Information 66 refers to any suitable data related to consumers 22 inside and outside consumer portfolio 20 that is used in payment portfolio optimization. For example, information 66 may include transaction information, campaign information, credit information, profile information, account information, and other suitable information related to processes in payment portfolio optimization system 10. Profile information may include business profile information such as whether a consumer is a small business owner, whether the business is a sole proprietorship, and other suitable information related to a business associated with a consumer.

In the illustrated embodiment, information 66 used in payment portfolio optimization is provided by issuer 70(a). In another embodiment, information 66 from issuer 70(a) may be pooled with information 66 from other entities such as other issuers. One advantage to pooling information 66 is that pooled information 66 could provide a better statistical basis for developing the propensity models. Another technical advantage of pooling information is that pooled information 66 could be used to more accurately define opportunities for revenue growth since they are based on information available from more than one entity.

In the illustrated embodiment, consumer 22(a) purchases a good or service at merchant 40 using portable consumer device 30(a) associated with an account with issuer 70(a) and consumer 22(c) purchases a good or service at merchant 40 using a check associated with an account with issuer 70(a). Consumer 22(a) interacts with access device 32(a) such as a POS terminal at merchant 40(a). For example, consumer 22(a) may have swiped their portable consumer device 30(a) through an appropriate slot of a cardreader in the POS terminal. Alternatively, the POS terminal may be a contactless reader, and portable consumer device 30(a) may be a contactless device such as a contactless card. A transaction authorization request is sent to acquirer 50(a) who sends it through payment processing network 60 to issuer 70(a). Issuer 70(a) sends an authorization message through payment processing network 60 to acquirer 50(a) indicating that the transaction is authorized (or is declined). Acquirer 50(a) forwards the authorization message to merchant 40(a).

After merchant 40(a) receives authorization message, access device 32(a) at merchant 40(a) may then provide authorization message to consumer 22(a). Authorization message may be displayed by access device 32(a), or may be printed out on a receipt.

At the end of the day, a normal clearing and settlement process can be conducted on the payment processing network 60. A clearing process is a process of exchanging financial details between a merchant 40 and an issuer 70 to facilitate posting to a consumer's account and reconciliation of the consumer's settlement position. Clearing and settlement can occur simultaneously. Information 66 related to this transaction is stored in database 64.

Diagnostics module 62 retrieves information 66 from issuer 70(a) about consumers 22 in consumer portfolio 20 to identify opportunities in consumer portfolio 20. An opportunity refers to a possibility of increasing net revenue to issuer 70(a) based on consumers 22 in consumer portfolio 20 under favorable circumstances. In other embodiments, diagnostics module 62 retrieves information 66 about consumers 22 outside of consumer portfolio 20 to identify opportunities such as procuring consumers for consumer portfolio 20.

Diagnostics module 62 performs consumer segmentation to divide consumer portfolio 20 into consumer segments based on segment definitions. In the illustrated example, diagnostics module 62 may select segment definitions of “carded” and “uncarded.” Based on the first definition, the first segment consists of consumers 22(a) and 22(b) that have portable consumer devices 30(a) and 30(b) associated with their accounts with issuer 70(a). Based on the second segment definition, the second segment consists of consumer 22(c) that doesn't have a portable consumer device 30(b). In another embodiment, diagnostics module 62 divided consumer portfolio 20 into any suitable number of segments.

Diagnostics module 62 evaluates the performance of consumer portfolio 20 and consumer segments within consumer portfolio 20 based on performance metrics to identify potential opportunities for issuer 70(a). Performance metrics refer to measures of performance. Some examples of performance metrics include penetration, attrition rate, activation, usage, average ticket value, and volume mix. Penetration of consumer portfolio 20 into a market refers to the percentage that consumer portfolio has entered the market. Attrition rate refers to the rate at which portable consumer devices 30 associated with accounts of consumers 22 have not been used. Activation refers to the percentage of portable consumer devices 30 associated with accounts of consumers 22 that have been activated and used once at a POS terminal. An active portable consumer device 30 refers to a portable consumer device 30 that has been activated and used at least once at a POS terminal. Usage refers to the number of transactions conducted using portable consumer devices 30 by consumers 22 as compared to other consumers 22 in consumer portfolio 20. In some cases, consumers are rated on a usage scale. For example, consumers 22 may be rated as a “light user,” a “medium user,” a “heavy user,” or a “super heavy user.” Average ticket value refers to the average value of transactions made by portable consumer devices 30 associated with accounts of consumers 22 in consumer portfolio 20. Performance metrics are determined based on input from issuer 70(a) or another suitable entity.

In some embodiments, diagnostics module 62 may also determine the penetration of consumer portfolio 20 and/or consumer segments into the market to identify potential opportunities. Penetration of consumer portfolio 20 into the consumer market is the percentage of consumers in the market that have accounts with issuer 70(a). Penetration of a consumer segment into the market is the percentage of consumers in the portion of the market related to that consumer segment that have accounts with issuer 70(a). For example, diagnostics module 62 may determine that there are five small business owners in the small business owner market, each of these small business owners has two business accounts so that there are a total of ten business accounts in the small business market where three are held by issuer 70(a). Since 30% of all business accounts in the small business market are held issuer 70(a), penetration of the issuer's consumer portfolio 20 into the small business market is 30%. In this example, diagnostics module 62 may determine that based on 30% penetration there is an opportunity for revenue growth in acquiring new business accounts with small business owners.

Once diagnostics module 62 has identified potential opportunities, diagnostics module 62 evaluates or sizes the opportunities by assessing the profitability of the identified opportunities. Profitability refers to the potential to generate net revenue to issuer 70(a). Net revenue is the gross revenue less expenses. Some expenses include marketing costs, account management costs, and rewards program costs. In some embodiments, diagnostics module 62 assesses the profitability of opportunities by consumer segment. In one embodiment, diagnostics module 62 performs a sensitivity analysis to assess the profitability of opportunities by consumer segment. A sensitivity analysis predicts the increased net revenue to issuer 70(a) if a given percentage of consumers in the consumer segment associated with the opportunity increases. For example, diagnostics module 62 may determine that there is potential for an increase in net revenue of $1 M to issuer 70(a) if 1% of its consumers that are “uncarded” were to become “carded.” Based on the results of the profitability assessment, diagnostics module 62 prioritizes and selects consumer segments with the most profitable opportunities. Diagnostics module 62 stores the selected consumer segments with the most profitable opportunities and information 66 related to these opportunities to database 64.

Financial modeling module 68 retrieves the selected consumer segments with the most profitable opportunities and information related these opportunities from database 64. Financial modeling module 68 develops one or more propensity models to determine the likelihood that consumers 22 in the selected consumer segments will respond favorably to marketing treatments so as to actualize the opportunities. Each propensity model is based on multiple performance metrics. An exemplary propensity model is based on penetration, activation, usage and attrition. Financial modeling module 68 ranks the selected consumer segments into deciles based on the likelihood that the consumers in the segments will perform in the most favorable way based on the multiple performance metrics. In some embodiments, the top tier of deciles consists of those consumer segments with the most promising consumers for maximizing revenue to issuer 70(a) and for targeting in a marketing plan.

Financial modeling module 68 designs marketing treatments that target the top tier of deciles resulting from the one or more propensity models. Financial modeling module 68 tests the marketing treatments based on the effects of multiple factors simultaneously to determine an optimal set of marketing treatments. Any suitable number or type of factor may be used. Some examples of factors include channel, rewards, pricing and creative. The channel factor may be direct mail or telemarketing. The rewards factor may be cash back or premium rewards. The pricing factor may be waive over-draft fee or don't waive over-draft fee. The creative factor may be zero liability or online reporting.

In some embodiments, financial modeling module 68 uses a factorial design to test the pilot model. A factorial design tests the effects of multiple factors simultaneously while reducing the number of test groups by half by pairing factors together in the test groups. For example, issuer 70(a) may want to test the performance of factors such as channel (direct mail or telemarketing), rewards (cash back or merchant offer), and pricing (waive overdraft fee or waive business account fee). For these three factors, there are 8 (2×2×2) possible combinations of marketing treatments. Using the factorial design, financial modeling module 68 can pair factors together, test 4 (2×2) combinations of the marketing treatments with paired factors, and extrapolate the results to the untested combinations.

The test results are used to determine a successful combination of marketing treatments that target the consumer characteristics of the top tier of deciles. A successful marketing plan with the successful marketing treatments is then delivered to issuer 70(a). The improved marketing plan may be delivered in any suitable form. In some cases, the improved marketing plan is delivered in a report to issuer 70(a). The report may be in any suitable form.

Modifications, additions, or omissions may be made to payment portfolio optimization system 10 without departing from the scope of the disclosure. The components of payment portfolio optimization system 10 may be integrated or separated according to particular needs. Moreover, the operations of payment portfolio optimization system 10 may be performed by more, fewer, or other system modules. Additionally, operations of payment portfolio optimization system 10 may be performed using any suitable logic comprising software, hardware, other logic, or any suitable combination of the preceding.

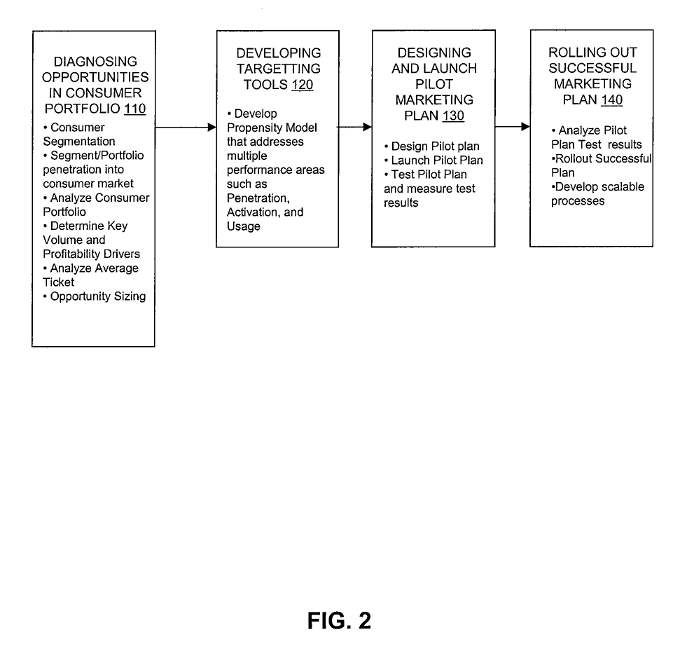

FIG. 2 is a flow chart illustrating a method of payment portfolio optimization that includes diagnosing opportunities in consumer portfolio 20 (step 110), developing targeting tools (step 120), designing and launching a pilot marketing plan (step 130), and rolling out a successful marketing plan (step 140), in accordance with an embodiment of the invention.

Diagnostics module 62 diagnoses opportunities in consumer portfolio 20 (step 110) to identify and evaluate potential opportunities in consumer portfolio 20 for increasing net revenue to issuer 70(a). In diagnosing opportunities, diagnostics module 62 performs consumer segmentation, segment/portfolio penetration into consumer market, analyzes consumer portfolio 20, determines key volume and profitability drivers, analyzes average ticket, and performs opportunity sizing, in any suitable order. In other embodiments, some, none, or all of these analyses may be performed by diagnostics module 62 when diagnosing opportunities.

Diagnostics module 62 performs consumer segmentation to divide consumer portfolio 20 into consumer segments based on segment definitions provided by issuer 70 or another suitable entity. In some embodiments, diagnostics module 62 may define segment definitions using historical data in information 66 retrieved from database 64. Diagnostics module 62 may use any appropriate method of segmentation. Some example methods of segmentation include the waterfall method of separating one or more segments from consumer portfolio 20 using corresponding segment definitions.

Using the waterfall method, consumer portfolio 20 is first divided into two or more segments based on a first segment definition. Each of these segments is then divided into two or more segments based on other segment definitions. Each of these segments may then be further divided into two or more segments based on other segment definitions. This process continues until a hierarchy of segments based on segment definitions is created from consumer portfolio 20. For example, consumer portfolio 20 may first be divided into segments consisting of consumers 22 that are “carded” or “uncarded.” The segment consisting of consumers 22 that are “carded” may be further separated into “active,” or “inactive.” The segment with consumers 22 that are “active” may be further separated into “light user,” “medium user,” “heavy user,” or “super-heavy user.” The segment with consumers 22 that are “inactive” may be separated into “potential user,” or “non-user.” Using this method, the following seven segments may result: 1) “open,” “carded,” “active,” and “light users;” 2) “open,” “carded,” “active,” and “medium users,” 3) “open,” “carded,” “active,” and “heavy user;” 4) “open,” “carded,” “active,” and “super-heavy user;” 5) “open,” “carded,” “inactive,” and “potential users;” 6) “open,” “carded,” “inactive,” and “non-user;” 7) “open” and “uncarded.”

Using the second method of segmentation, one or more segments can be separated from consumer portfolio 20 based on one or more segment definitions. For example, issuer 70(a) may provide the segment definition: “consumers located in the Northeast region of the United States.” Based on the provided definition, diagnostics module 62 separates a consumer segment consisting of consumers in consumer portfolio 20 that are located in the Northeast region of the United States. In another example, diagnostics module 62 may divide consumer portfolio 20 into two segments based on two separate segment definitions of having and not having a rewards plan. The first segment consists of consumers 22 having accounts with rewards plans. The second segment consists of consumers 22 having accounts that are not associated with rewards plans.

Diagnostics module 62 determines the segment/portfolio penetration into the consumer market to identify potential opportunities in each consumer segment for increased net revenue to issuer 70(a). In other embodiments, segment/portfolio penetration may identify potential opportunities that lie outside consumer portfolio 20. For example, diagnostics module 62 may determine that one of issuer's consumer segments e.g. “heavy users” penetrates 10% of the “heavy users” market associated with that consumer segment. Based on this result, diagnostics module 62 may determine that issuer 70(a) has a potential opportunity to increase revenue by marketing to “heavy users” outside of consumer's portfolio 20 that do not yet have an account with issuer 70(a).

Diagnostics module 62 also analyzes consumer portfolio 20 of issuer 70(a) based on various performance metrics. For example, financial modeling module 68 may analyze the attrition rate of accounts in consumer portfolio 20 is 90%. Based on this analysis, diagnostics module 62 may determine that issuer 70(a) has a problem with attrition and that there is an opportunity to reduce attrition rates in its consumer portfolio 20.

Diagnostics module 62 also determines key volume drivers, key profitability drivers, and average ticket values. Volume refers to the total dollar amount of completed transactions by consumers 22 in consumer portfolio over a time period. A volume driver refers to consumer characteristics that control volume. Some examples of volume drivers are how many consumers 22 have portable consumer devices 30 and how many of the portable consumer devices 30 are activated. For example, diagnostics module 62 may analyze information 66 and determine that 85% of the volume is generated by business accounts associated with portable consumer devices 30. Based on this information, diagnostics module 62 may determine that its main volume driver is whether the business account is “carded.”A profitability driver refers to those consumer characteristics that control profitability. An example of a profitability driver is whether the account is associated with a rewards program that has provided rewards which is an expense to the issuer and decreases net revenues.

Diagnostics module 62 sizes or evaluates the opportunities in each consumer segment or segment opportunities based on the volume drivers, the profitability drivers, and the average ticket values. In some embodiments, diagnostics module 62 performs a sensitivity analysis to predict the increased net revenue to issuer 70(a) if a certain percentage of consumers in each segment were to increase. Based on the sensitivity analysis, diagnostics module 62 prioritizes and selects consumer segments as input to a propensity model developed by financial modeling module 68.

Financial modeling module 68 develops targeting tools (step 120) to identify the most promising consumer segments to be targeted by the marketing plan. Financial modeling module 68 develops a propensity model that addresses penetration, activation, and usage. In other embodiments, other suitable propensity models could be used and other suitable performance metrics could be assessed. The propensity model predicts the likelihood that each consumer in the selected consumer segments will open an account with a portable consumer device 30 (penetration), activate that portable consumer device 30 (activation), and then spend with the portable consumer device 30 (usage) that they activated. The propensity model also predicts the ROI for the selected consumer segments. Financial modeling module 68 ranks the consumers into deciles based on the predicted likelihood and the predicted return on investment. Based on these analyses, financial modeling module 68 selects the top tier of deciles to be targeted in the marketing plan.

Financial modeling module 68 designs and launches a pilot marketing plan (step 130). The pilot plan includes a group of marketing treatments that target the consumer segments in the top tier of deciles resulting from the propensity model. Designing and launching the pilot plan includes designing the pilot plan, launching the pilot, testing the pilot plan, and measuring the test results.

Financial modeling module 68 tests the marketing treatments in the pilot plan based on a factorial design to determine the optimal combination of marketing treatments. The factorial design tests the effects of multiple factors simultaneously to determine an optimal set of marketing treatments. In one embodiment, financial modeling module 68 uses the four factors: channel (direct mail or telemarketing), rewards (cash back or merchant offer), pricing (waive overdraft fee or waive business account fee), and creative (zero liability, online reporting). Based on these four factors, there are 16 (2×2×2×2) possible combinations of marketing treatments. Financial modeling module 68 pairs two levels of factors: cash back and waive overdraft fee, cash back and waive business account fee, and merchant offer and waive overdraft fee, merchant offer and waive business account fee, zero liability and direct mail, online reporting and telemarketing, online reporting and direct mail, zero liability and telemarketing. Based on these pairings, eight test groups are designed. Each paired group acts as a control group for the others. The test results for the eight paired groups are extrapolated to the eight untested combinations.

Financial modeling module 68 rolls out a successful plan (step 140) with the optimal combination of marketing treatments. Rolling out a successful plan involves analyzing the pilot plan test results, rolling out a successful plan, and developing scalable processes. Financial modeling module 68 analyzes the test results from the factorial design to determine an optimal combination of marketing treatments that target consumers in the top tier of deciles. Financial modeling module 68 develops a successful marketing plan that includes the optimal combination of marketing treatments. Financial modeling module 68 rolls out the successful marketing plan.

Financial modeling module 68 delivers to issuer 70(a) the marketing plan with the optimal combination of marketing treatments that target only the most promising consumers in the top tier of deciles. In one case, the marketing plan is delivered in the form of a report.

Modifications, additions, or omissions may be made to the method without departing from the scope of the disclosure. The method may include more, fewer, or other steps. Additionally, steps may be performed in any suitable order without departing from the scope of the disclosure.

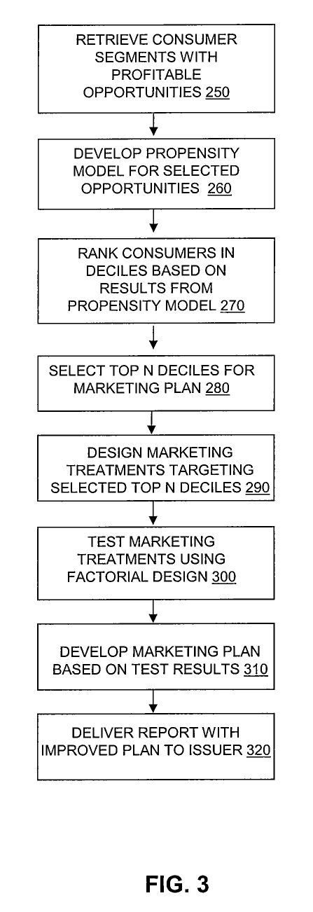

FIG. 3 is a flowchart illustrating a method of payment portfolio optimization, in accordance with an embodiment of the invention. As shown, the method of payment portfolio optimization begins with financial modeling module 68 retrieving consumer segments with profitable opportunities from a database 64 (step 250).

Financial modeling module 68 develops a propensity model for the retrieved consumer segments (step 260) based on one or more performance metrics such as penetration, activation, usage, and attrition. In one example embodiment, the propensity model is based on penetration into the business account market, activation of portable consumer device 30, and usage of portable consumer device 30. In this example, the propensity model predicts the likelihood that each consumer in the consumer segments will open a business account with a portable consumer device 30, activate the portable consumer device 30, and then spend with the portable consumer device 30.

Financial modeling module 68 ranks the consumer segments into deciles based on the predicted likelihoods developed in the propensity model (step 270). Financial modeling module 68 selects the top N deciles for a marketing plan (step 280). In one embodiment, financial modeling module 68 selects the top 3 deciles (N=3) for the marketing plan. In this embodiment, financial modeling module 68 is selecting the top 30% of the consumers that are most likely to open an account, activate their portable consumer devices 30, and then spend.

Financial modeling module 68 designs marketing treatments that target the top N deciles resulting from the propensity model (step 290). Financial modeling module 68 tests the marketing treatments using factorial design (step 300). These tests result in an optimal combination of marketing treatments. In one embodiment, Financial modeling module 68 tests the marketing treatments with four factors that include channel, rewards, pricing and creative and each of these factors has two levels. Based on these four factors, there are sixteen possible combinations of marketing treatments. In this embodiment, financial modeling module 68 pairs factors together based on the factorial design so that there are eight possible combinations marketing treatments to test and the results of these eight tests are extrapolated to the other eight possible combinations. Financial modeling module 68 selects the combination with the most favorable test results as the optimal combination of marketing treatments.

Financial modeling module 68 develops the marketing plan based on the test results (step 310). Financial modeling module 68 uses the results of the tests to develop a marketing plan with the optimal combination of marketing treatments that target the top N deciles. After developing the marketing plan, financial modeling module 68 delivers a report with the marketing plan to issuer 70(a) (step 320).

Modifications, additions, or omissions may be made to the method without departing from the scope of the disclosure. The method may include more, fewer, or other steps. Additionally, steps may be performed in any suitable order without departing from the scope of the disclosure.

It should be understood that the present disclosure as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the system components, modules, and/or operations described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus (e.g., a computer), and may be present on or within different computational apparatuses within a system or network.

A recitation of “a”, “an” or “the” is intended to mean “one or more” unless specifically indicated to the contrary.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

What is claimed is:

1. A method for payment portfolio optimization, comprising:
retrieving a plurality of consumer segments of a consumer portfolio from a diagnostics module, the plurality of consumer segments having potentially profitable opportunities;
developing a propensity model on a computer based on at least one performance metric;
determining, using the propensity model, a likelihood that consumers in each of the plurality of consumer segments will perform favorably;
selecting a set of consumer segments from the plurality of consumer segments based on the determined likelihood; and
designing a plurality of marketing treatments for the selected set of consumer segments.

2. The method for payment portfolio optimization of claim 1, further comprising providing to a first issuer a report having the designed plurality of marketing treatments.

3. The method for payment portfolio optimization of claim 1,
testing the designed plurality of marketing treatments;
developing a marketing plan from the designed plurality of marketing treatments based on the testing;
providing a report having the marketing plan to a first issuer.

4. The method for payment portfolio optimization of claim 3,
wherein testing the designed plurality of marketing treatments includes using factorial design.

5. The method for payment portfolio optimization of claim 1, wherein the at least one performance metric comprises penetration, activation, usage, and attrition.

6. The method for payment portfolio optimization of claim 1, wherein one of the designed plurality of marketing treatments is associated with a product for the set of consumer segments.

7. The method for payment portfolio optimization of claim 1, wherein selecting a set of consumer segments from the plurality of consumer segments based on the determined likelihood comprises:
ranking into a plurality of deciles the consumer segments based on the determined likelihood; and
selecting consumer segments in a top tier of deciles from the plurality of deciles.

8. The method for payment portfolio optimization of claim 1, further comprising:
pairing marketing treatments in the designed plurality of marketing treatments;
forming combinations of marketing treatments from the paired marketing treatments;
testing the combinations of marketing treatments;
selecting one of the combinations of marketing treatments based on the testing; and
designing a marketing plan using the selected one of the combinations of marketing treatments.

9. A system of payment portfolio optimization, comprising:
a database storing information; and
a financial modeling module on a computer, the financial modeling module coupled to the database, the financial modeling module configured to:
retrieve a plurality of consumer segments of a consumer portfolio from a diagnostics module, the plurality of consumer segments having profitable opportunities;
develop a propensity model based on at least one performance metric;
determine, using the propensity model, a likelihood that consumers in each of the plurality of consumer segments will perform favorably;
select a set of consumer segments from the plurality of consumer segments based on the determined likelihood; and
design a plurality of marketing treatments for the selected set of consumer segments.

10. The system of payment portfolio optimization of claim 9, wherein the financial modeling module is further configured to provide to a first issuer a report having the designed plurality of marketing treatments.

11. The system of payment portfolio optimization of claim 9, wherein the financial modeling module is further configured to:
test the designed plurality of marketing treatments;
develop a marketing plan from the designed plurality of marketing treatments based on the testing;
provide a report having the marketing plan to a first issuer.

12. The system of payment portfolio optimization of claim 11, wherein the financial modeling module is configured to test the designed plurality of marketing treatments includes using factorial design.

13. The system of payment portfolio optimization of claim 9, wherein the at least one performance metric comprises penetration, activation, usage, and attrition.

14. The system of payment portfolio optimization of claim 9, wherein one of the designed plurality of marketing treatments is associated with a product for the set of consumer segments.

15. The system of payment portfolio optimization of claim 9, wherein the financial modeling module configured to select a set of consumer segments from the plurality of consumer segments based on the determined likelihood is configured to:
rank into a plurality of deciles the consumer segments based on the determined likelihood; and
select consumer segments in a top tier of deciles from the plurality of deciles.

16. The system of payment portfolio optimization of claim 9, wherein the financial modeling module is further configured to:
pair marketing treatments in the designed plurality of marketing treatments;
form combinations of marketing treatments from the paired marketing treatments;
test the combinations of marketing treatments;
select one of the combinations of marketing treatments based on the testing; and
design a marketing plan using the selected one of the combinations of marketing treatments.
